(19) United States
(12) Patent Application Publication
(10) Pub. No.: US 2016/0121334 A1
(43) Pub. Date: May 5, 2016

(54) HAMMER CRUSHER

(71) Applicant: CHANGSHA SHENXIANG UNIVERSAL MACHINE CO., LTD., Hunan (CN)

(72) Inventor: Zhigang Hao, Hunan (CN)

(21) Appl. No.: 14/893,499

(22) PCT Filed: May 27, 2014
(86) PCT No.: PCT/CN2014/078512

§ 371 Date: Nov. 23, 2015

(30) Foreign Application Priority Data
May 28, 2013 (CN) 201310203830.X

(51) Int. Cl. B02C 13/28; B02C 13/04

(52) U.S. Cl. CPC B02C 13/28; B02C 13/04

(57) ABSTRACT

A hammer crusher includes a shell provided with a feed port, a main shaft rotatably arranged on the shell, a hammer bracket arranged on the main shaft, and a hammer shaft arranged on the hammer bracket, wherein at least one hammerhead is arranged on the hammer shaft, and the at least one hammerhead includes at least one material moving hammerhead configured to axially move materials. The material inside the crushing cavity can be compulsively moved axially by the at least one material moving hammerhead. Thus, the crushing time of the materials can be prolonged, and on the other hand the granule with small size can easily pass through, which leads to a larger yield and a lower power consumption.

### TECHNICAL FIELD

This application claims the benefit of priority to Chinese patent application No. 201310203830.X titled “HAMMER CRUSHER” and filed with the Chinese State Intellectual Property Office on May 28, 2013, the entire disclose of which is incorporated herein by reference.

### BACKGROUND

A hammer crusher is a crushing device which has a long application history and a wide application range. The hammer crusher is generally used in intermediate-crushing operation and fine-crushing operation and is mainly used in the heat-engine plants, mines, the chemical industry, building materials industry and the like. The structure and operating principle of the hammer crusher are described as follows, after being fed through a feed port, the materials to be crushed are struck by a hammer rotating at a high speed to be crushed, a sieve plate is arranged below the hammer crusher, the material granules of a size smaller than the sieve openings fall under the sieve plate and become produces, and the material granules of a size larger than the sieve openings are remained in the crusher and continue to be crushed. The existing hammer crusher has the following disadvantages.

1. Products crushed by the existing hammer crusher have large granule sizes, which leads to a small ratio of crushing. When the product requires a smaller granule size, either the production yield is rapidly reduced, or a fine crusher is additionally required, and in this case, the process is complicated and multi-stage crushing sections and crushing devices have to be employed.

2. In the case that materials to be crushed have a high content of water or mud, the hammer crusher has a lower yield and even a crushing cavity may be blocked. Therefore, it is required to increase the size of the sieve opening in the crushing cavity, which in turn results in a larger granule size.

3. If the existing hammer crusher is employed to produce a product having a small granule size, the power consumption may be rapidly increased.

Therefore, an urgent technical issue to be addressed by the person skilled in the art is to produce a product of a small granule size, and to improve the yield and reduce the power consumption while producing the product of a small granule size.

### SUMMARY

In view of this, an object of the present application is to provide a hammer crusher, which is adaptive for materials having a high content of water and mud, is suitable to produce a product with a small granule size, and can improve the yield and reduce the power consumption while producing the product with a small granule size.

In order to achieve the above object, the following technical solutions are provided according to the present application.

A hammer crusher includes a shell provided with a feed port at a top, a main shaft rotatably arranged on the shell, a hammer bracket arranged on the main shaft, and a hammer shaft arranged on the hammer bracket, wherein at least one hammerhead is arranged on the hammer shaft, and the at least one hammerhead includes at least one material moving hammerhead configured to axially move materials.

Preferably, in the hammer crusher, the material moving hammerhead at least has one material moving inclined surface.

Preferably, in the hammer crusher, the material moving hammerhead is a single-inclined surface material moving hammerhead having one inclined surface or a multi-inclined surface material moving hammerhead having at least two inclined surfaces.

Preferably, in the hammer crusher, the material moving inclined surface of the material moving hammerhead is a planar inclined surface or a curved inclined surface.

Preferably, in the hammer crusher, the material moving hammerhead is a conical inclined-surface annular material moving hammerhead, an outer surface of which is a conical inclined surface.

Preferably, in the hammer crusher, the material moving hammerhead is a helical annular material moving hammerhead, an outer surface of which is provided with annular helical blades being axially arranged.

Preferably, in the hammer crusher, the annular helical blade of the helical annular material moving hammerhead is a single-start helix or a multi-start helix, and a profile of the annular helix is a square tooth, a triangular tooth, a zigzag tooth or a trapezoid tooth.

Preferably, in the hammer crusher, the material moving hammerhead is a multi-head annular inclined-surface material moving hammerhead, an outer surface of which is provided with a material moving inclined surface.

Preferably, in the hammer crusher, the material moving hammerhead is an inclined-scraper annular material moving hammerhead, an outer surface of which is provided with an inclined scraper assembly.

Preferably, in the hammer crusher, each of the hammerheads is the material moving hammerhead.

Preferably, in the hammer crusher, the at least one hammerhead includes a common hammerhead and the material moving hammerhead which are configured to cooperate with each other.

According to the above technical solutions, the hammer crusher according to the present application is provided with at least one material moving hammerhead configured to force the materials to axially move, thus the materials to be crushed in the crushing cavity can be forced to axially move. Thus, on one hand, the number of times and the time of the crushing operation for the materials can be increased; and on the other hand, small granules can more easily pass through the sieve openings, the sieve surface can be continuously forcedly moved and swept by the material moving hammerhead configured to force the materials to axially move. During this process, the small granules in the materials can easily pass through the sieve openings and the adhesive wet mud and small granules can be forcedly pushed out of the sieve openings. In addition, the hammer crusher according to the present application may have a larger yield and a lower power consumption.

Compared with the conventional technology, the present application has the following technical effects.

(1) The material moving hammerhead configured to axially move the materials is employed in the present application, thus, compared with a conventional hammer crusher, the hammer crusher according to the present application has a smaller crushing fineness, and has a large yield while having a smaller crushing fineness, thereby enlarging the field of application of the hammer crusher.

(2) According to the present application, the number of times and the time of the crushing operation for the materials are increased and the product produced by crushing has a smaller granule size, thus different requirements of producing coarse products, medium products or fine products can be met by one crusher, thereby simplifying the manufacturing process.

(3) In the present application, the number of times and the time of the crushing operation for the materials are increased, and the material moving hammerhead is configured to continuously move and sweep the sieve surface and continuously force small granules to pass through the sieve openings more quickly, thus the hammer crusher is suitable to crush various adhesive wet materials.

(4) According to the present application, the materials with the qualified granule size can be cleaned out of the crusher in time, the number of times of the crushing operation for the materials is many and effective, thus compared with the conventional technology, the hammer crushes according to the present application has a larger yield, a smaller steel consumption and a lower energy consumption.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for the person skilled in the art, other drawings may be obtained based on these drawings without any creative efforts.

FIG. 1 is a schematic view showing the structure of a hammer crusher according to an embodiment of the present application;

FIG. 2 is a sectional view of the hammer crusher according to the embodiment of the present application;

FIG. 3 is a schematic view showing the structure of an inclined-surface material moving hammerhead according to an embodiment of the present application;

FIG. 4 is a side view of FIG. 3;

FIG. 5 is a sectional view of FIG. 4 taken along plane A-A according to an embodiment of the present application;

FIG. 6 is a sectional view of FIG. 4 taken along plane A-A according to another embodiment of the present application;

FIG. 7 is a schematic view showing the structure of an inclined-surface material moving hammerhead according to another embodiment of the present application;

FIG. 8 is a side view of FIG. 7;

FIG. 9 is a sectional view of FIG. 8 taken along plane B-B according to the embodiment of the present application;

FIG. 10 is a schematic view showing the structure of a hammer crusher according to another embodiment of the present application;

FIG. 11 is a sectional view of FIG. 10 taken along plane C-C;

FIG. 12 is a top view of a helical annular material moving hammerhead according to an embodiment of the present application;

FIG. 13 is a front view of the helical annular material moving hammerhead according to the embodiment of the present application;

FIG. 14 is a perspective view of an inclined-scraper annular material moving hammerhead according to an embodiment of the present application;

FIG. 15 is a schematic view showing the structure of a hammer crusher according to yet another embodiment of the present application; and

FIG. 16 is a sectional view of FIG. 15 taken along plane D-D.

### REFERENCE NUMERALS

| 1 | normal hammerhead; | | |
|---|---|---|---|
| 2a | single-inclined surface material moving hammerhead, | | |
| 2b | multi-inclined surface material moving hammerhead, | | |
| 2c | conical inclined-surface annular material moving hammerhead, | | |
| 2d | helical annular material moving hammerhead, | | |
| 2e | multi-head annular inclined-surface material moving hammerhead, | | |
| 2f | inclined-scraper annular material moving hammerhead, | | |
| 3 | sieve plate, | 4 | feed port, |
| 5 | main shaft, | 6 | hammer bracket, |
| 7 | hammer shaft, | 8 | normal annular hammerhead, |

| | |
|---|---|
| 9 | common multi-start annular hammerhead. |

### DETAILED DESCRIPTION

A core of the present application is to provide a hammer crusher, which is suitable to produce a product with a small granule size, and can improve the yield and reduce the power consumption while producing the product with a small granule size.

In order to achieve the above technical effects, it is required to force materials to be crushed to axially move in a crushing cavity, and during the moving process, qualified granules are continuously pushed out of the crusher through holes of a sieve plate. For crushing the materials and forcing the materials to be crushed to axially move, a device configured to force the materials to axially move is further required in addition to a normal crushing hammer.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

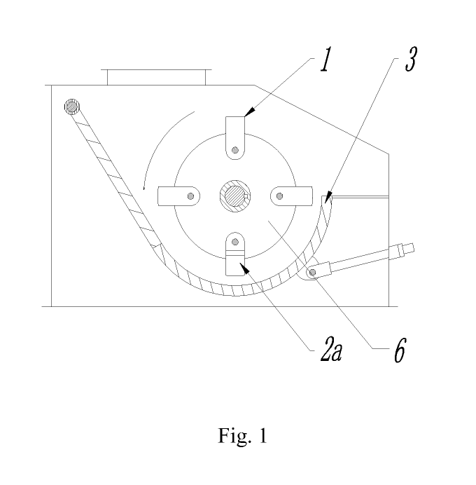

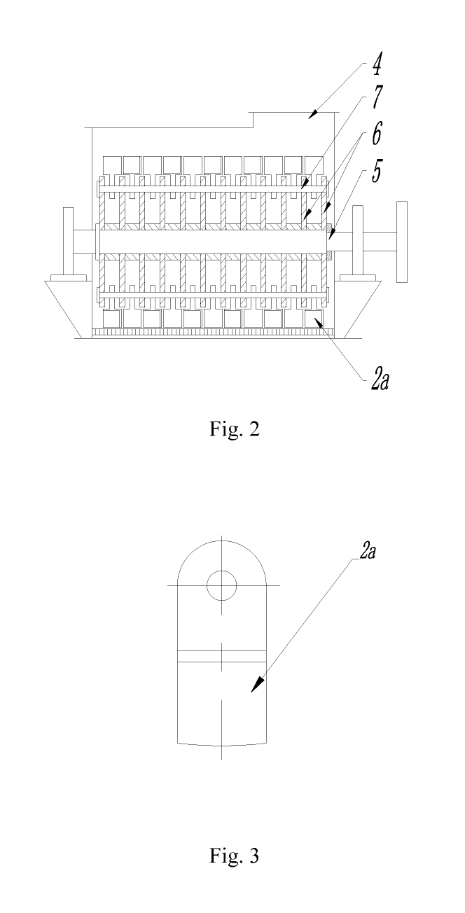

Reference is made to FIGS. 1 and 2, FIG. 1 is a schematic view showing the structure of a hammer crusher according to an embodiment of the present application, and FIG. 2 is a sectional view of the hammer crusher according to the embodiment of the present application.

The hammer crusher according to the embodiment of the present application includes a shell, a main shaft 5, a hammer bracket 6, a hammer shaft 7 and a hammerhead.

A feed port 4 is provided at the top of the shell, and materials can be fed into a crushing cavity in the shell via the feed port 4. The main shaft 5 is rotatably arranged on the shell, and may be arranged in the shell by a bearing bracket. The hammer bracket 6 is arranged on the main shaft 5, the hammer shaft 7 is arranged on the hammer bracket 6, and at least one of hammerheads is arranged on the hammer shaft 7. At least one of the hammerheads is a material moving hammerhead configured to axially move materials, and other hammerheads may be normal hammerheads 1.

When being rotated, the main shaft 5 may drive the hammerheads (including the material moving hammerhead) to rotate through the hammer bracket 6. After the materials to be crushed are fed through the feed port 4, the materials are crushed by the hammerheads. The material moving hammerhead has functions of crushing the materials and forcing the materials to axially move, and further can clean a sieve surface and push small granules to pass through sieve openings more quickly during the process of moving the materials. The crushed materials are axially moved while being crushed, thereby increasing the number of times and the time of the crushing operation for the materials being crushed. In this way, the materials may be crushed more fine without being crushed overly, and the small granules generated by crushing the materials can pass through the sieve openings more easily and quickly, to become products.

When materials having a high viscidity and a high content of water are fed into the crusher, coals for a circulating fluidized bed boiler in a thermal power plant are described as an example, it is desired that the coals to be fed into the boiler has a granule size within several millimeters. However, it is extremely difficult to crush adhesive wet coals into granules having a granule size within several millimeters in a common crusher. In the present application, the adhesive wet cores are axially moved while being crushed, thus, on one hand, the coals are crushed more fine; and on the other hand, the crushed small granules of the size of several millimeters are continuously forcedly pushed and swept to pass through the sieve openings, to become qualified products.

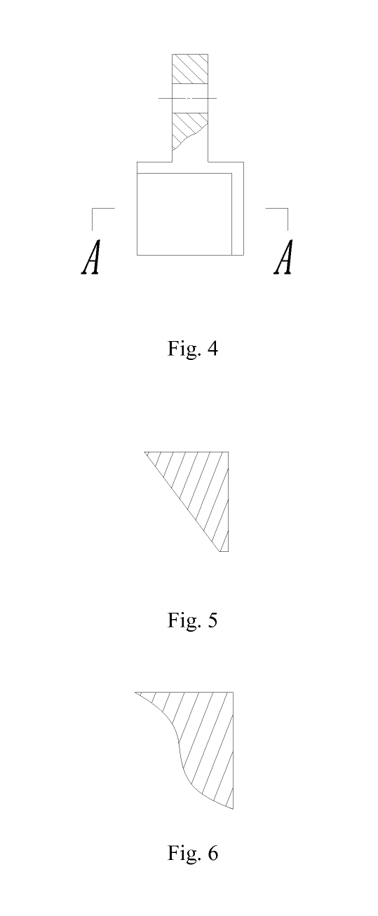

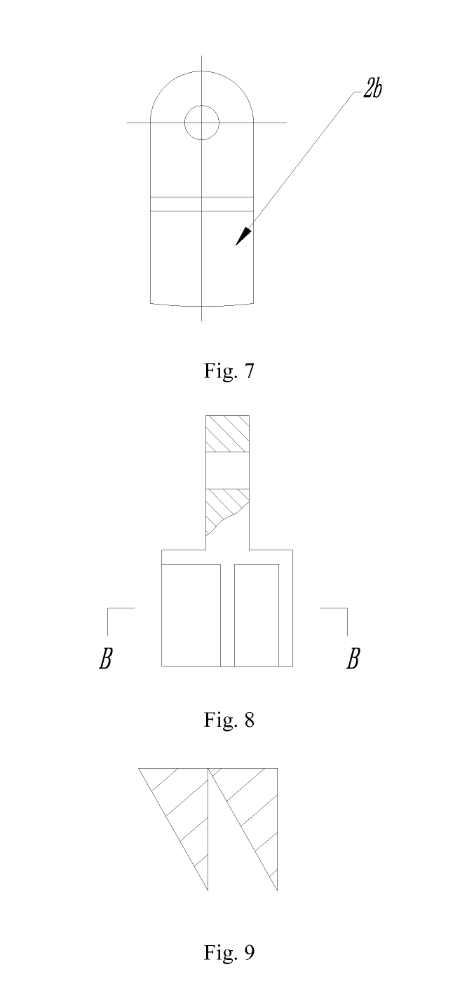

Reference is made to FIGS. 3 to 9, FIG. 3 is a schematic view showing the structure of an inclined-surface material moving hammerhead according to an embodiment of the present application, FIG. 4 is a side view of FIG. 3, FIG. 5 is a sectional view of FIG. 4 taken along plane A-A according to an embodiment of the present application, FIG. 6 is a sectional view of FIG. 4 taken along plane A-A according to another embodiment of the present application, FIG. 7 is a schematic view showing the structure of an inclined-surface material moving hammerhead according to another embodiment of the present application, FIG. 8 is a side view of FIG. 7, and FIG. 9 is a sectional view of FIG. 8 taken along plane B-B according to the embodiment of the present application.

In an embodiment of the present application, the material moving hammerhead at least has one material moving inclined surface. It can be appreciated by those skill in the art that during the rotation of the hammerhead, the inclined surface provided on the hammerhead may function as an inclined scraper or have a spiral-like screwing-in effect, i.e. generate an effect for forcedly moving the materials. It will be appreciated by those skilled in the art that, in addition to providing the hammerhead with the material moving inclined surface, other manners may be employed to move the materials, for example providing a helical blade.

The material moving inclined surface may be formed by removing a part of the normal hammerhead 1.

The material moving hammerhead may be a single-inclined surface material moving hammerhead 2a having one inclined surface, or a multi-inclined surface material moving hammerhead 2b having at least two inclined surfaces. A material moving inclined surface of the material moving hammerhead may be a planar surface or a curved surface.

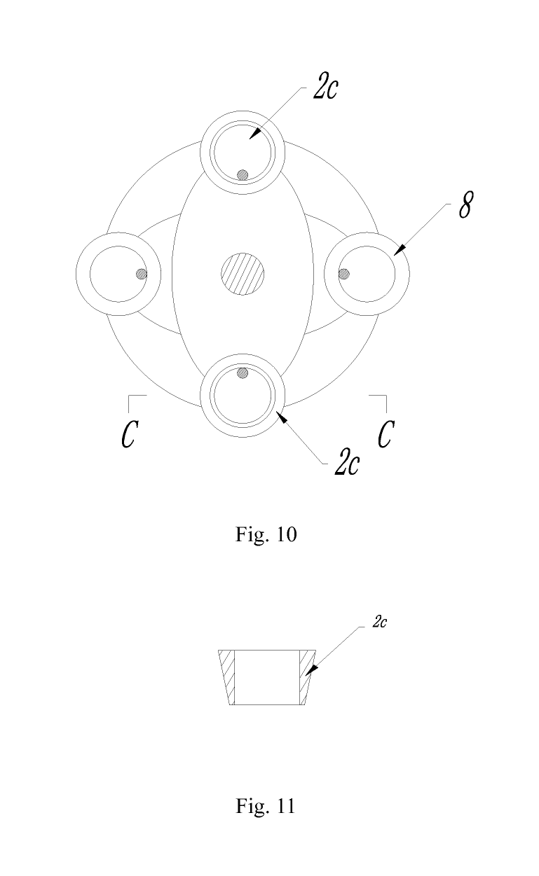

Reference is made to FIGS. 10 and 11, FIG. 10 is a schematic view showing the structure of a hammer crusher according to another embodiment of the present application, and FIG. 11 is a sectional view of FIG. 10 taken along plane C-C.

The material moving hammerhead may be a conical inclined-surface annular material moving hammerhead 2c, an outer surface of which is a conical inclined surface. That is, for a hammer crusher having a common annular hammer 8, the material moving hammerhead of the hammer crusher is the conical inclined-surface annular material moving hammerhead 2c. That is, the outer surface of the material moving hammerhead has a conical structure, and a longitudinal section of the conical inclined-surface annular material moving hammerhead 2c is an inclined line (which may be an inclined straight line or an inclined curved line).

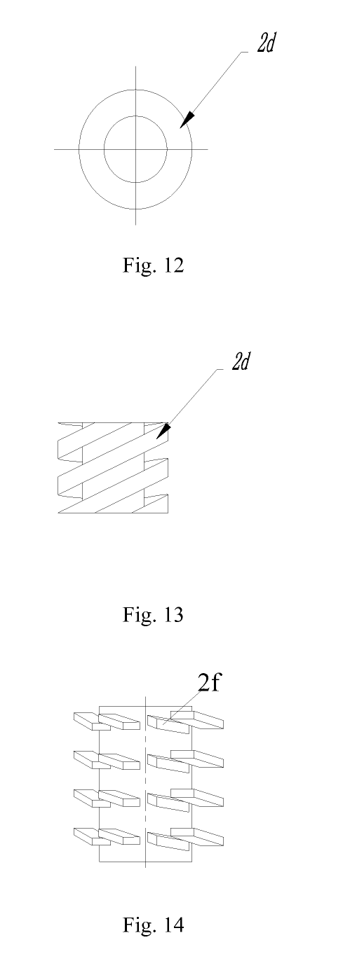

Reference is to FIGS. 12, 13 and 14, FIG. 12 is a top view of a helical annular material moving hammerhead 2d according to an embodiment of the present application; FIG. 13 is a front view of the helical annular material moving hammerhead 2d according to the embodiment of the present application, and FIG. 14 is a perspective view of an inclined-scraper annular material moving hammerhead 2f according to an embodiment of the present application.

The material moving hammerhead may be a helical annular material moving hammerhead 2d, an outer surface of which is provided with annular helical blades being axially arranged. That is, for a hammer crusher having a common annular hammer 8, the material moving hammerhead of the hammer crusher is the helical annular material moving hammerhead 2d; that is, the outer surface of the material moving hammerhead 2d has a helical blade structure.

A helical blade surface can be understood as an inclined curved surface, however, the helical annular material moving hammerhead 2d has two mechanisms for axial moving the materials, on one hand, when the helical annular material moving hammerhead 2d revolves at a high speed, the inclined curved surface thereof has a function of pushing the materials to axially move; and on the other hand, when the helical annular material moving hammerhead 2d strikes the materials, under a combined effect with the sieve plate, the helical annular material moving hammerhead 2d may rotate on its axis, and once the blade-like helix rotates on its axis, the effect of pushing the materials to axially move may be generated.

The annular helical blade of the helical annular material moving hammerhead 2d may be a single-start helix or a multi-start helix. The profile of the annular helical blade may be a square tooth, a triangular tooth, a zigzag tooth, a trapezoid tooth or the like.

An inclined scraper on the surface of the inclined-scraper annular material moving hammerhead 2f in FIG. 14 may be formed by cutting the helical blade on the surface of the helical annular material moving hammerhead 2d into segments, may have a helix-like shape formed by arranging multiple inclined scrapers at an angle, or can be formed by randomly distributing multiple inclined scrapers at an angle on an outer cylindrical surface of an annular body.

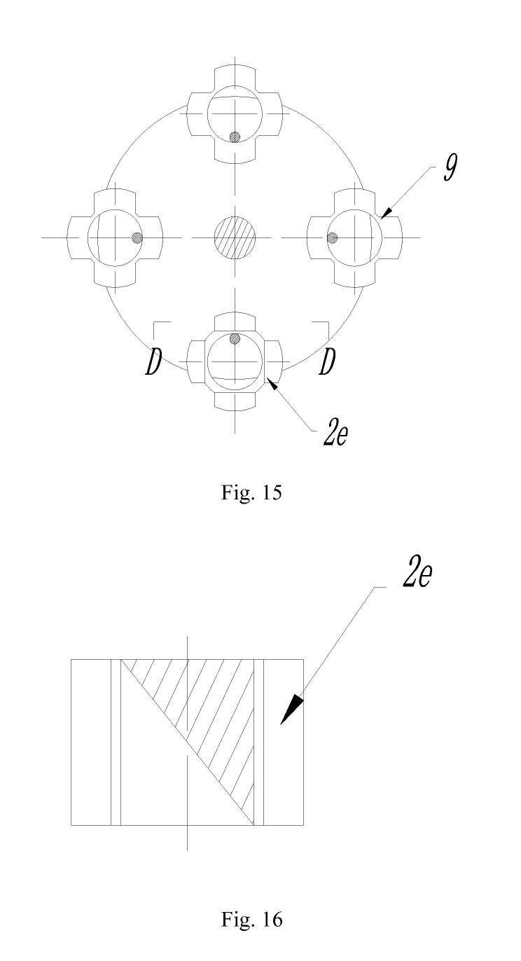

Reference is made to FIGS. 15 and 16, FIG. 15 is a schematic view showing the structure of a hammer crusher according to yet another embodiment of the present application, and FIG. 16 is a partial sectional view of FIG. 15 taken along plane D-D.

The material moving hammerhead may be a multi-head annular inclined-surface material moving hammerhead 2e, an outer surface of which is provided with a material moving inclined surface. That is, for a hammer crusher having a common multi-head annular hammer 9, the material moving hammerhead of the hammer crusher is the multi-head annular inclined-surface material moving hammerhead 2e; that is, the outer surface of the material moving hammerhead 24 is an inclined surface.

In an embodiment of the present application, all of the hammerheads can each be the material moving hammerhead or can include material moving hammerheads and common hammerheads 1 in cooperation with each other. One material moving hammerhead is arranged in a disk surface of each hammer bracket 6, and the common hammerheads are arranged at other positions in the disk surface of the hammer bracket 6; or, multiple material moving hammerheads may be arranged in the disk surface of the hammer bracket 6; or hammerheads arranged in the disk surface of the hammer bracket 6 may each be the material moving hammerhead.

In the present application, only one material moving hammerhead or only one common hammerhead 1 may be mounted on each of the hammer shafts 7 randomly in different combinations.

The structure of the material moving hammerhead configured to axially moving materials according to the first embodiment is described in detail in the following embodiments. That is, the material moving hammerhead may be the single-inclined surface material moving hammerhead 2a, the multi-inclined surface material moving hammerhead 2b, the conical inclined-surface annular material moving hammerhead 2c, the helical annular material moving hammerhead 2d, the multi-head annular inclined-surface material moving hammerhead 2e or the inclined-scraper annular material moving hammerhead 2f. It can be appreciated by those skilled in the art that, the single-inclined surface material moving hammerhead 2a, the multi-inclined surface material moving hammerhead 2b, the conical inclined-surface annular material moving hammerhead 2c, the helical annular material moving hammerhead 2d, the multi-head annular inclined-surface material moving hammerhead 2e and the inclined-scraper annular material moving hammerhead 2f are all specific structure forms of the material moving hammerhead.

In conclusion, the present application has the following technical effects.

(1) The material moving hammerhead configured to axially move the materials is employed in the present application, thus, compared with a conventional hammer crusher, the hammer crusher according to the present application has a smaller crushing fineness, and has a large yield while having a smaller crushing fineness, thereby enlarging the field of application of the hammer crusher.

(2) According to the present application, the number of times and the time of the crushing operation for the materials are increased and the product produced by crushing has a smaller granule size, thus different requirements of producing coarse products, medium products or fine products can be met by one crusher, thereby simplifying the manufacturing process.

(3) In the present application, the number of times and the time of the crushing operation for the materials are increased, and the material moving hammerhead is configured to continuously sweep the sieve surface and continuously force small granules to pass through the sieve openings more quickly, thus the hammer crusher is suitable to crush various adhesive wet materials.

(4) According to the present application, the materials with the qualified granule size can be cleaned out of the crusher in time, the number of times of the crushing operation for the materials is many and effective, and additionally, the materials will not be excessively crushed, thus compared with the conventional technology, the hammer crushes according to the present application has a larger yield, a smaller steel consumption and a lower energy consumption.

The various embodiments in the specification are described in a progressive manner, each of the embodiments is mainly focused on describing its differences from other embodiments, and references may be made among these embodiments with respect to the same or similar portions among these embodiments.

Based on the above description of the above described embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A hammer crusher, comprising:
a shell provided with a feed port;
a main shaft rotatably arranged on the shell;
a hammer bracket arranged on the main shaft; and
a hammer shaft arranged on the hammer bracket (6), wherein at least one hammerhead is arranged on the hammer shaft, and the at least one hammerhead comprises at least one material moving hammerhead configured to axially move materials.

2. The hammer crusher according to claim 1, wherein the material moving hammerhead at least has one material moving inclined surface.

3. The hammer crusher according to claim 2, wherein the material moving hammerhead is a single-inclined surface material moving hammerhead having one inclined surface or a multi-inclined surface material moving hammerhead having at least two inclined surfaces.

4. The hammer crusher according to claim 2, wherein the material moving inclined surface of the material moving hammerhead is a planar inclined surface or a curved inclined surface.

5. The hammer crusher according to claim 1, wherein the material moving hammerhead is a conical inclined-surface annular material moving hammerhead, an outer surface of which is a conical inclined surface.

6. The hammer crusher according to claim 1, wherein the material moving hammerhead is a helical annular material moving hammerhead, an outer surface of which is provided with annular helical blades being axially arranged.

7. The hammer crusher according to claim 6, wherein the annular helical blade of the helical annular material moving hammerhead is a single-start helix or a multi-start helix, and a profile of the annular helical blade is a square tooth, a triangular tooth, a zigzag tooth or a trapezoid tooth.

8. The hammer crusher according to claim 1, wherein the material moving hammerhead is a multi-head annular inclined-surface material moving hammerhead, an outer surface of which is provided with a material moving inclined surface.

9. The hammer crusher according to claim 1, wherein the material moving hammerhead is an inclined-scraper annular material moving hammerhead, an outer surface of which is provided with an inclined scraper assembly.

10. The hammer crusher according to claim 1, wherein each of the hammerheads is the material moving hammerhead.

11. The hammer crusher according to claim 1, wherein the at least one hammerhead comprises a common hammerhead and the material moving hammerhead which are configured to cooperate with each other.

12. The hammer crusher according to claim 2, wherein each of the hammerheads is the material moving hammerhead.

13. The hammer crusher according to claim 2, wherein the at least one hammerhead comprises a common hammerhead and the material moving hammerhead which are configured to cooperate with each other.

14. The hammer crusher according to claim 5, wherein each of the hammerheads is the material moving hammerhead.

15. The hammer crusher according to claim 5, wherein the at least one hammerhead comprises a common hammerhead and the material moving hammerhead which are configured to cooperate with each other.

16. The hammer crusher according to claim 6, wherein each of the hammerheads is the material moving hammerhead.

17. The hammer crusher according to claim 6, wherein the at least one hammerhead comprises a common hammerhead and the material moving hammerhead which are configured to cooperate with each other.

18. The hammer crusher according to claim 8, wherein each of the hammerheads is the material moving hammerhead.

19. The hammer crusher according to claim 8, wherein the at least one hammerhead comprises a common hammerhead and the material moving hammerhead which are configured to cooperate with each other.
